(19) United States
(12) Patent Application Publication
(10) Pub. No.: US 2007/0057402 A1
(43) Pub. Date: Mar. 15, 2007

(54) Method for producing a mould and the thus obtained mould

(75) Inventors: Serge Da Silva, Perpignan (FR); Pierre Gros, Colomiers (FR); Cedric Leguen, Dremil Lafage (FR); Jacques Prosdocimi, Tournefeuille (FR); Sylvain Puybouffat, Balma (FR)

Correspondence Address: YOUNG & THOMPSON, 745 SOUTH 23RD STREET, 2ND FLOOR, ARLINGTON, VA, 22202, US

(73) Assignee: 6T-MIC INGENIERIES, ALBI (FR)

(21) Appl. No.: 10/574,810

(22) PCT Filed: Oct. 5, 2004
(86) PCT No.: PCT/FR04/02506

§ 371 Date: Apr. 5, 2006

(30) Foreign Application Priority Data
Oct. 6, 2003 (FR) 0311682

(51) Int. Cl. B29C 33/40

(52) U.S. Cl. 264/220; 249/114.1

(57) ABSTRACT

The invention relates to a method for producing a mold for molding objects in a material, called the moldable material, whereby a pattern of the objects to be molded is used and is covered with a material, called the molding material, wherein expanded graphite is used as the molding material, the pattern (3) is covered with expanded graphite to form a continuous layer of expanded graphite or a plurality of separated layers (5, 6) of expanded graphite distributed over the pattern, and the layer(s) of expanded graphite are then compressed against the pattern so as to obtain for each layer a block of consolidated graphite which is impermeable to the moldable material. A variant of the invention consists in utilizing at least one pre-consolidated layer of expanded graphite which is recompressed in at least one direction so as to have a density ranging from 30 to 50 kg/m³.

The invention relates to a method for producing a mold. In what follows the term “molding” refers to the action of producing an object by means of a mold. In cases when no confusion with the preceding definition is possible, the term “molding” may also be used to refer to the action of producing a mold from a part called a pattern. The term “molding material(s)” refers to the material(s) used to produce a mold; the term “moldable material(s)” refers to the material(s) used to produce the objects molded by means of the mold.

The known methods for producing molds differ in the molding materials they utilize, in the different stages of producing the mold, in the shape of the mold obtained and in its mode of utilization. The selection of one method from the others is determined by the complexity of the shape to be reproduced, by the number of objects to be produced with the mold, by the moldable material(s), etc.

Among the known mold-making methods which allow the production of molds able to produce objects made of plaster, cement, resin or other duroplastic material, expanded foamed material, etc., the following may be mentioned:
simple molding, consisting in producing a formwork casing inside which the pattern is placed and fixed, filling the casing with the molding material, selected from plaster, silicone elastomers and alginate according to the shape of the pattern, then demolding the pattern. The mold may be produced in a single part, then cut if required, or produced in two or more parts. Such a method is undoubtedly relatively simple but involves a production time which is frequently long as a result of the time needed for drying or hardening of the molding material;
dip molding, consisting in immersing the pattern in a liquid molding material during the hardening phase of the latter, repeating the operation until a coating has been deposited on the pattern, waiting until the coating is completely dry and then detaching it from the pattern. The molding material is selected from wax, latex or other suitable duroplastic material. The limitations of such a method are the number of handling operations required and the hardening time of the molding material;
press molding, consisting in applying a molding material to the surface of the pattern, pressing the molding material against the pattern or inversely in order to produce an impression, then in unsticking the pattern. To carry this out, ribbons treated with plaster or a pasty molding material, selected from plaster and mastic, are used to obtain a rigid mold, or a gelatinous material selected from latex, silicone elastomers and alginate is used to obtain a flexible mold, in one or more parts, which mold is covered with a rigid support casing of plaster or plaster-treated ribbons, which casing is split if required to allow demolding. A laminatable material may also be used, for example, by applying pieces of glass fiber mat to the surface of the pattern and impregnating same with polyester resin. Here, too, the required operations are numerous and, moreover, manual and are mostly impossible to automate, and the drying or curing times of the molding material and/or the casing material reduce the productivity of the method;
flow molding within a casing, consisting in protecting the pattern with an insulating film (for example, of aluminum foil), covering it with a uniform layer of a pasty material such as plastilina or clay, pressure-forming a casing of plaster by means of the pattern thus covered, detaching said casing after the plaster has set and forming a number of flow holes in the casing, removing the pasty material and the insulating film from the pattern, replacing the pattern in the plaster casing and closing same in a sealed manner (except for the flow holes), and pouring into the casing a silicone elastomer which occupies the space between the pattern and the casing. The mold may be made in one or more parts. This method is obviously especially lengthy and complex.

In addition, among the known mold and mold-making methods utilized in foundry work (such molds are intended to receive molten metal alloys), the following may be mentioned:
molds made of sand (silica grains, etc.) or other refractory non-siliceous material (zirconium, chromite, olivine, bauxite). Such a mold is constructed in two parts, each corresponding substantially to one half of the pattern, by compressing sand in a flask. The sand is thus squeezed between the flask and the pattern, and then the pattern is withdrawn. The cohesion of the sand is ensured by a binder, selected in particular from moist clay, silicone gels, synthetic resins, cement, etc., or by ceramic-type bonding produced at high temperature. Although it is the most widely used, this method has numerous disadvantages:
   the sand mold obtained is destroyed on demolding and is therefore used only once; recycling of the sand is made difficult or even impossible by the presence of the binders;
   handling of the sand is cumbersome and dangerous;
   volatile silica powders necessitate the wearing of a mask;
   the quantities of sand needed determine the location of the foundry (close to a sand pit);
   because the sand mold is cold, solidification begins along the walls of the mold and must end in risers (additional molding volume provided so that the volume of liquid metal poured is greater than the volume of solid metal of the finished part, in view of the contraction of the metal as it solidifies); cooling of thick portions of the object is very slow; conversely, cooling of thin portions of the object is rapid and makes filling difficult; the rate of filling must be greater than the rate of solidification;
   the surface quality of the mold, and therefore of the object cast in such a mold, is coarse; finishing operations (for example, polishing) on the object or the mold are necessary;
   the object cast has parting lines along the plane of the joint between the two parts of the mold;
mold shells, forming a two-part metal mold made from a molding material selected from cast irons, aluminum alloys, brasses, cupro-aluminums and steels, depending on the metal alloy which the mold is intended to receive and the method for introducing said liquid alloy into the mold (alloy cast by gravity, under low pressure, under high pressure, centrifugally). The shells are moulded in a flask containing the pattern and/or are machined to the shape of the pattern. Unlike the sand mold, the shells are reusable, have good dimensional accuracy and good surface quality. On the other hand, they are especially costly and, unlike sand molds, do not allow controlled cooling of the molten alloy contained in them;
lost wax casting, consisting in producing a destructible pattern (in contrast to the permanent patterns used in the other methods described previously) made of wax using a conventional molding method, covering the wax pattern with a refractory product and, after hardening of the refractory product forming the mold, melting the wax and extracting it from the mold, then baking the latter. This method enables a high-precision mold to be produced which allows objects to be cast without parting lines or surface defects. On the other hand, it is relatively complex and costly, necessitates the production of one pattern per mold produced, and provides a mold that can be used only once, since it must be destroyed to release the object cast.

It should be noted that, for the production of very long metal bars, it is also known to use a mold made of graphite, called an ingot mold, which acts as a die into which the molten alloy is poured continuously. The graphite used to make such an ingot mold is an artificial graphite made from base materials containing carbon such as blacks (from smoke or crude petroleum), cokes (metallurgical or from crude petroleum), and natural graphites and industrial graphites (originating from re-ground electrographitic materials). After being ground, sifted and selected, the powdery base materials are mixed with binders such as tars, pitches, and phenolic and furfuryl resins; the pastes obtained are processed by milling and drawing and then are baked, re-ground and re-mixed. They are then extruded to form round blanks or hollow slugs; the blanks or slugs are then baked to cause carbonization of the binder and agglomeration of the base material containing carbon, then are graphitized by heating to more than 2000° C. It should be noted that the blanks or slugs undergo major shrinkage during the firing and take on a clinkered surface which requires subsequent machining. To protect it from oxidation and corrosion, the surface of the ingot mold thus obtained is generally covered with a deposit of pyrocarbon (obtained by pyrolysis of a hydrocarbon such as methane at a temperature ranging from 800 to 2000° C.) or with a foil of flexible graphite known under the trade name Papyex® (obtained by laminating flakes of expanded natural graphite). The production of an ingot mold of this kind is obviously especially complex, cumbersome and costly.

It is the object of the invention to mitigate these disadvantages by proposing a method for producing a mold which is particularly simple, rapid and inexpensive.

It is an object of the invention, in particular, to propose a mold-making method which is extremely rapid and includes a considerably reduced number of operations which, in addition, may, if appropriate, be automated without using complex or costly specific machinery.

It is another object of the invention to provide a mold-making method which allows the production of a mold having high dimensional precision and excellent surface quality without specific surface improvement (finishing by machining, polishing, deposition of a finishing coating, etc.). It is also an object of the invention to provide a mold with which objects without parting lines can be produced.

In general, it is also an object of the invention to propose a method which does not involve machining operations or mold finishing operations.

It is a further object of the invention to propose a method by which a mold resistant to corrosion and oxidation is produced without specific surface treatment (chemical or electrochemical treatment, protective coating, etc.).

It is a further object of the invention to propose a method permitting the use of a permanent pattern which can be used for the production of a plurality of identical molds.

It is a further object of the invention to propose a mold-making method by which a refractory mold adapted to foundry work can be produced. In a preferred version, it is an object of the invention to provide a foundry mold in which the temperature of the molten alloy can be controlled.

It is another object of the invention to propose a mold-making method by which there can be produced a mold that can be used a plurality of times, in particular a very large number of times, without significant deterioration of its surface quality, including cases when the moldable material is corrosive and/or is heated to a very high temperature (molten alloy, for example).

It is another object of the invention to propose a mold-making method which is simple to carry out and is without major risks to the operator. In particular, the proposed method does not necessitate any special precautions (such as wearing a mask or special one-piece garment) for its implementation.

It is a further object of the invention to provide a mold which is recyclable.

In a first version, the invention relates to a method for producing a mold for molding objects in a material called the molding material, whereby a pattern of the objects to be molded is used and the pattern is covered with a material, called the molding material, wherein expanded graphite is used as the molding material, the pattern is covered with expanded graphite to form a continuous layer of expanded graphite or a plurality of separated layers of expanded graphite distributed over the pattern, and then the layer(s) of expanded graphite are compressed against the pattern in such a way as to obtain for each layer a consolidated graphite block which is impermeable to the moldable material.

A distinction can be made between patterns called closed patterns, the external surface of which to be impressed is a closed surface, and patterns called open patterns, the surface of which to be impressed is an open surface. In other words, a closed pattern is an object which is intended to be reproduced in its totality, with all its faces, while an open pattern is a part of an object, such as a face or a side (the rest of the object not having to be molded). In the case of an open pattern, it is often simpler to form only a single layer of expanded graphite. In the case of a closed pattern, if a single continuous layer of expanded graphite is formed, this layer envelops the pattern on all sides. It is therefore appropriate either to cut the consolidated block obtained in order to remove the pattern, if the latter is a permanent pattern, or to destroy the pattern (by melting or chemical reaction) if the latter is a destructible pattern (of wax or polystyrene, for example). As a variant, a plurality of layers of expanded graphite is formed around the pattern. In particular, a first layer may be formed on one side of the pattern and a second layer on the other side of the pattern, so as to completely envelop the pattern, in order to obtain a two-part mold (i.e. in two blocks). As a variant, the forming of more than two layers around the pattern is not excluded. The number of layers is chosen, in particular, as a function of the complexity of the shape to be molded (i.e. the pattern). It should be noted that two adjacent layers are separated, for example, by a separation sheet which is preferably flat and rigid to provide a flat joint surface.

In a second version, the invention relates to a method for producing a mold for molding objects in a material, called the moldable material, in which a pattern of the objects to be molded is used and is covered with a material, called the molding material, wherein expanded graphite is used as the molding material, at least one layer, called the pre-consolidated layer and formed of expanded graphite recompressed in at least one direction so as to have a density ranging from 30 to 50 kg/m³, is used, the pre-consolidated layer(s) is/are placed on the pattern and said pre-consolidated layer(s) are then compressed against the pattern so that the pattern is covered and a block of consolidated graphite impermeable to the moldable material is obtained for each layer.

In other words, in this second version the expanded graphite is not placed directly (in expanded form) on the pattern but is provided in the form of prefabricated layers of lightly recompressed expanded graphite which can be manipulated—because they are consolidated—but are still malleable under low pressure.

In its two versions, therefore, the invention consists, firstly, in using expanded graphite as the molding material and in pressing said material against a pattern in a still expanded (non-cohesive) form or in a pre-consolidated form (lightly recompressed expanded graphite), and secondly, if a plurality of layers of graphite (expanded or pre-consolidated) are formed, in simultaneously compressing said layers around the pattern. In particular, the invention proposes a method for producing a mold in two or more parts, whereby all the parts of the mold are produced at the same time by common operations (the layers being compressed together).

The simplicity of the processes according to the invention is in contrast to the previously known techniques referred to in the introduction. These processes are also surprising for their speed of execution: a simple instantaneous compression of the layer(s) of expanded or pre-consolidated graphite is sufficient to form the mold; the pattern can be removed immediately without the need to wait for drying or hardening or baking of the molding material, as is the case with the previous techniques. Apart from their simplicity and speed of execution, the processes according to the invention have numerous advantages:
they provide the possibility of producing molds of complex shape;
the mold obtained has excellent dimensional precision and surface quality, enabling the usual finishing operations (machining, polishing, etc.) to be dispensed with; the objects molded using such a mold are without parting lines;
demolding of the objects molded using such a mold is facilitated by the lubricating character of the recompressed expanded graphite;
the mold obtained has behavior which is advantageous mechanically (rigidity, etc.), chemically (resistance to corrosion and oxidation, etc.) and thermally (refractory, small dimensional variation when subjected to large thermal variations, etc.), enabling it to be used numerous times and endowing it with a long service life. In particular, such a mold retains good surface quality despite intensive use in a frequently aggressive environment both thermally (elevated temperature of the moldable material, large variations in temperature between times when not in use and during operations of pouring the moldable material, etc.), and chemically (corrosion, oxidation, etc.);
it is not necessary to produce a flask for the mold, it being possible to compress the layer(s) of expanded or pre-consolidated graphite directly between the pattern and the plate(s) of a press;
the process is without danger, expanded graphite being neither toxic nor hazardous;
the pattern used can be permanent, enabling the production of a plurality of molds from the same pattern;
the mold obtained can be easily recycled; it is sufficient to exfoliate the graphite of the consolidated block(s) using an intercalation solution.

It should be noted that an expanded natural graphite, which if required is ground (but preferably is as obtained after exfoliation), is preferably used as the expanded graphite.

According to the invention, the layer(s) of expanded or pre-consolidated graphite is/are advantageously compressed so as to obtain a consolidated block or blocks having a density greater than 40 kg/m³ in the case of a mold intended for low-temperature applications (moldable material of the type of plaster, elastomer, plastics material), and preferably greater than 100 kg/m³ in the case of a mold intended for high-temperature applications (foundry mold, moldable material of the type of molten alloy). A density greater than 100 kg/m³ imparts excellent thermal diffusivity to the consolidated block(s) of graphite, allowing regulation of the temperature of the mold and therefore of the rate of cooling of the moldable material. At all events, a density greater than 40 kg/m³ ensures complete impermeability of the mold to the finest and most liquid moldable materials, and an especially fine surface quality of the mold.

The layer(s) of expanded or pre-consolidated graphite is/are compressed in a plurality of directions, in particular in three orthogonal directions. As a variant, the layer(s) of expanded or pre-consolidated graphite is/are compressed in a single direction.

The choice between these two implementations depends, firstly, on the shape of the pattern and, secondly, on the desired thermal properties (conductivity, thermal diffusivity, etc.) of the graphite mold. Multiaxial compression (compression in a plurality of directions) is preferred in the case of a pattern having a complex, even convoluted, shape to ensure correct molding of the pattern. Uniaxial compression (compression in a single direction) leads to the production of a consolidated block or blocks of graphite which is/are highly anisotropic (the thermal or other properties obtained in the compression direction “C” being different from those obtained in all directions “A” orthogonal to direction “C”), while compression in all directions (the result achieved, for example, by compressing in three orthogonal directions) leads to the production of a block or blocks of consolidated graphite which is/are slightly anisotropic. By varying the compression stresses applied in each direction to each layer of expanded or pre-consolidated graphite, the properties, in particular the thermal and mechanical properties, of the mold obtained can be adjusted and controlled.

The layer(s) of expanded or pre-consolidated graphite is/are preferably subjected to a single compression operation in each direction. In other words, the layer(s) of expanded or pre-consolidated graphite is/are compressed only once in each direction.

According to the invention, the layer(s) of expanded or pre-consolidated graphite is/are advantageously subjected to a single compression operation, whether the layer(s) is/are compressed in a single direction or in a plurality of directions simultaneously. In the first version of the invention (the case in which the expanded graphite is placed directly on the pattern) the molding of the pattern according to the invention is therefore reduced to only two steps: the formation of one (or more) layers of graphite around the pattern, then compression.

As a variant, the layer(s) of expanded or pre-consolidated graphite is/are subjected, in at least one direction, to a plurality of distinct compression operations. This implementation may be advantageous in the first version of the invention. For example, a first compression adapted to consolidate the layer(s) of expanded graphite so that it/they they can be manipulated is carried out in this direction, and then a second compression adapted to impart a desired density to the consolidated block(s) is carried out.

According to the invention, in its first version, at least one layer of expanded graphite is advantageously covered, at least partially, with a layer of expanded vermiculite and all the layers formed are then compressed together so as to obtain, for each layer of vermiculite formed, a block, called a mixed block, of consolidated graphite/vermiculite, that is, a block comprising a layer of consolidated vermiculite and a layer of consolidated graphite, which block is also impermeable to the moldable material.

Similarly, in the second version of the invention, use is made of at least one pre-consolidated layer, called a mixed layer, formed from at least two superimposed layers, one of expanded graphite and another of expanded vermiculite, compressed together in at least one direction in such a way that the graphite has a density ranging from 30 to 50 kg/m³ and the vermiculite is consolidated. Each mixed pre-consolidated layer used is placed on the pattern in such a way that its graphite layer is oriented towards the pattern. Compression of such a mixed pre-consolidated layer against the pattern leads to the production of a mixed block as defined previously. It is possible to use at least one pre-consolidated layer of graphite and at least one mixed pre-consolidated layer for the production of the same mold.

The inventors have therefore noted with surprise that it is possible to compress together superimposed layers of expanded graphite and expanded vermiculite and to achieve not only consolidation of each layer, despite the structural differences (in terms of crystalline arrangement, granulometry, mode of consolidation, etc.) and the mechanical differences (resistance to compression, viscosity, etc.) between graphite and vermiculite, but also a bonding of said layers. This last result seems surprising if one considers that the graphite is consolidated first and forms an ordered laminated structure the parallel flakes of which can slide with respect to one another, imparting a lubricating character to the recompressed graphite, while consolidation of the vermiculite occurs only after that of the graphite and leads to a chaotic structure. One might therefore have expected that the vermiculite, which, moreover, has a granulometry greater than that of the graphite, could not anchor itself to the smooth and slippery surface of the consolidated layer of graphite. Bonding nevertheless occurs, and afterwards a slight imbrication of the graphite surfaces and vermiculite grains is observed at the interface between the consolidated layers.

According to the invention, therefore, a mold is obtained which comprises an “internal” portion of recompressed expanded graphite intended to be in contact with the moldable material, and an “external” portion of recompressed expanded vermiculite at least partially covering the graphite portion. As the recompressed expanded vermiculite is a very good thermal insulator, the vermiculite portion constitutes an insulating protection which proves useful in the case of a mold designed to receive a moldable material which is heated to a high temperature. It allows the mold to be manipulated during the operations of molding objects without risk of burning. It should be noted that, in the case when the moldable material is poured at high temperature (molten alloy, for example), the thermal properties of the mold obtained by a method according to the invention are particularly advantageous: the good thermal conductivity and diffusivity of the recompressed expanded graphite make the mold obtained a hot mold (in contrast to the sand mold). This characteristic of the mold according to the invention obviates the mold-filling problems encountered in the previous techniques, which result from premature cooling of the moldable material in contact with a cold mold while the pouring operations are not completed. This characteristic also enables homogenous molds to be obtained. In addition, and above all, it allows the temperature of the mold to be regulated, and therefore the rate of cooling of the moldable material to be controlled, as explained below.

According to the invention, heating/cooling elements, such as a part of an electrical circuit (resistors) or of a hydraulic circuit, are placed in at least one layer of expanded or pre-consolidated graphite during its formation (when the graphite is in the expanded form). It should be noted that if a mixed pre-consolidated layer is used the heating/cooling elements are arranged in the graphite layer. Bearing in mind that the recompressed expanded graphite is a good thermal conductor (in particular in the direction(s) of compression), which also has low thermal inertia, the heating/cooling elements are used to control the temperature of the mold and therefore the rate of cooling and solidification of the moldable material (molten alloy, for example). It should also be noted that, in the presence of such heating/cooling elements, the compression stresses applied to form the mold are chosen sufficiently low as not to damage said elements, and in particular sufficiently low as to impart to the block(s) a density (for the graphite) of less than 400 kg/m³.

As a variant (or optionally in combination), at least one passage adapted to receive a heating/cooling fluid is formed directly in the graphite mass of at least one block, at least one tube which is destructible (by chemical reaction, heating, etc.) or removable being placed within the corresponding layer of expanded or pre-consolidated graphite during its formation, said tube or tubes being destroyed or withdrawn once said block has been consolidated. The compression stresses are selected sufficiently high to obtain a graphite density imparting fluid-tightness and mechanical strength to each passage formed. For example, the layer(s) of expanded or pre-consolidated graphite are preferably compressed in such a way that the consolidated block has a density greater than 150 kg/m³.

As a variant or in combination, it is possible, as a result of the optical selectivity and the good thermal diffusivity of the recompressed expanded graphite, to heat the mold, or more generally to control its temperature, without contact, by exposing at least one graphite face, called the exterior face, of at least one mixed consolidated or graphite block to a source of infrared radiation located outside and at a distance from the mold. “Exterior face” is understood to mean a graphite face of the graphite or mixed layer, and therefore of the corresponding consolidated block, intended to be oriented towards the outside of the mold and to be visible when the mold is used, so that it can be exposed to a source of infrared radiation.

According to the invention, during the compression of the graphite layer(s) open concave forms, herein called capture forms, which are able to trap infrared waves, are advantageously impressed in at least one exterior face of at least one layer of expanded or pre-consolidated graphite (mixed or not). The impressed capture forms have, in particular, at least one frontal (open) dimension ranging from 1 μm to 2 cm, preferably from 100 μm to 1 cm, and a depth ranging from 1 μm to 10 cm, preferably from 5 mm to 5 cm.

The presence of capture forms improves the supply of calories by such radiation heating: an incident wave entering the interior of a capture form undergoes multiple reflections on the opposed faces of the capture form; the energy of the wave is finally absorbed almost completely by the graphite in the region of such a capture form (the proportion of the incident flux reflected outside the form, and therefore lost, is very small). Moreover, by increasing the surface area of the exterior face, the presence of capture forms also contributes to facilitating not only the supply of calories but also the dissipation of calories as the graphite block cools. Finally, the capture forms reduce the thermal inertia of the consolidated graphite block, which is already low as a result of the intrinsic properties of recompressed expanded graphite.

The impressed capture forms may be linear impressions such as straight or curved slots, grooves, troughs, etc., having a circular, square or triangular, etc., cross-section, or punctual impressions having a pyramidal, conical, hemispherical or cylindrical shape (square or circular cross-section), etc., or far more complex shapes. The geometry of the impressed forms is selected as a function of the wavelengths to be absorbed and of the thermal response desired for the consolidated graphite block.

In this way, the invention allows a mold to be provided with means for regulating its temperature without the necessity of equipping the mold with additional heating/cooling elements, or of providing an additional step in the mold-producing method to implement these means. The capture forms are produced directly in the graphite mass at the same time as the consolidated graphite blocks are formed, during the compression of the layers of expanded or pre-consolidated graphite. Furthermore, through the intrinsic properties of graphite, the capture forms are produced with extreme dimensional accuracy, so that efficient trapping of the waves is achieved, provided the geometry and the dimensions of the capture forms are appropriately selected as a function of the type of waves to be trapped. The production of the capture forms is controlled precisely without the need to employ complex and costly specific precision tooling.

It should be noted that if one or more layers of expanded graphite and vermiculite is/are formed and one or more mixed pre-consolidated layers (graphite/vermiculite) is/are used, heating of the mold by radiation is possible only if at least one of the exterior faces of the mold (visible during use of the latter) is made of graphite and is not, therefore, covered with vermiculite. It is into this face or faces that the capture forms are advantageously impressed.

The two versions of the invention apply, in particular, to the production of a foundry mold.

They also apply to the molding of a part of the human body, such as a hand, an arm, a leg or even a face, for orthopedic purposes, for the subsequent molding of orthoses or prostheses, but also for artistic purposes. It should be noted that it is possible to use the method according to the invention to produce an orthosis directly in graphite. The method may also prove useful for the cinema industry (production of a hand mold or a face mask, etc.). For these applications the second version of the invention is preferred. Light compression is sufficient to produce an accurate and complete mold. It should be noted that if the pattern is a face, this is an open pattern (only one side is to be reproduced) and only a single pre-consolidated layer is necessary.

The scope of the invention includes a mold obtained by a method according to the invention, and in particular a foundry mold, a mold, called an orthopedic mold, for molding orthoses or prostheses, and an art mold (for reproducing a work of art of the sculpture, statue type, etc.).

According to the invention, the mold advantageously includes at least one consolidated block, called a mixed block, comprising at least two bonded layers, including a layer of recompressed expanded graphite and a layer of recompressed expanded vermiculite at least partially covering the graphite layer.

According to the invention, the mold advantageously includes at least one consolidated mixed or graphite block having at least one face, called the exterior face (visible from the outside when the mold is used), of graphite, which is provided with impressed concave open forms, called capture forms, adapted to trap infrared waves. The capture forms have at least one frontal dimension ranging from 1 μm to 2 cm, preferably from 100 μm to 1 cm, and a depth ranging from 1 μm to 10 cm, preferably from 5 mm to 5 cm.

The scope of the invention also includes a method for molding objects, wherein a mold according to the invention is used. Said scope includes, in particular, a foundry method for casting a molten alloy whereby a foundry mold according to the invention is used, and a method for producing an orthosis or prosthesis whereby an orthopedic mold according to the invention is used, and also a method for reproducing a works of art of the sculpture type, whereby the art mold according to the invention is used.

The invention also relates to a mold and a mold-making method characterized in combination by all or some of the characteristics mentioned hereinbefore and hereinafter.

Other objects, characteristics and advantages of the invention will be apparent from the following description, which relates to the appended drawings showing preferred embodiments of the invention, which are given solely as non-limiting examples, in which drawings:

FIG. 1 is a schematic sectional view of a press used to produce a mold according to the first version of the invention;

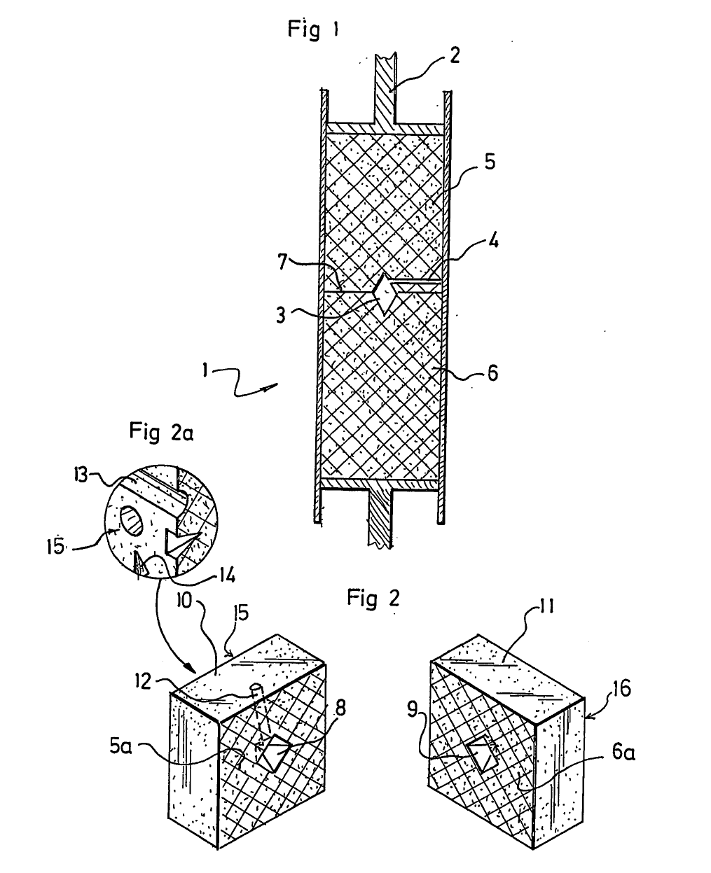

FIG. 2 is a perspective view of a two-part mold according to the invention;

FIG. 2a is a cut-away perspective view of an exterior face of the mold of FIG. 2;

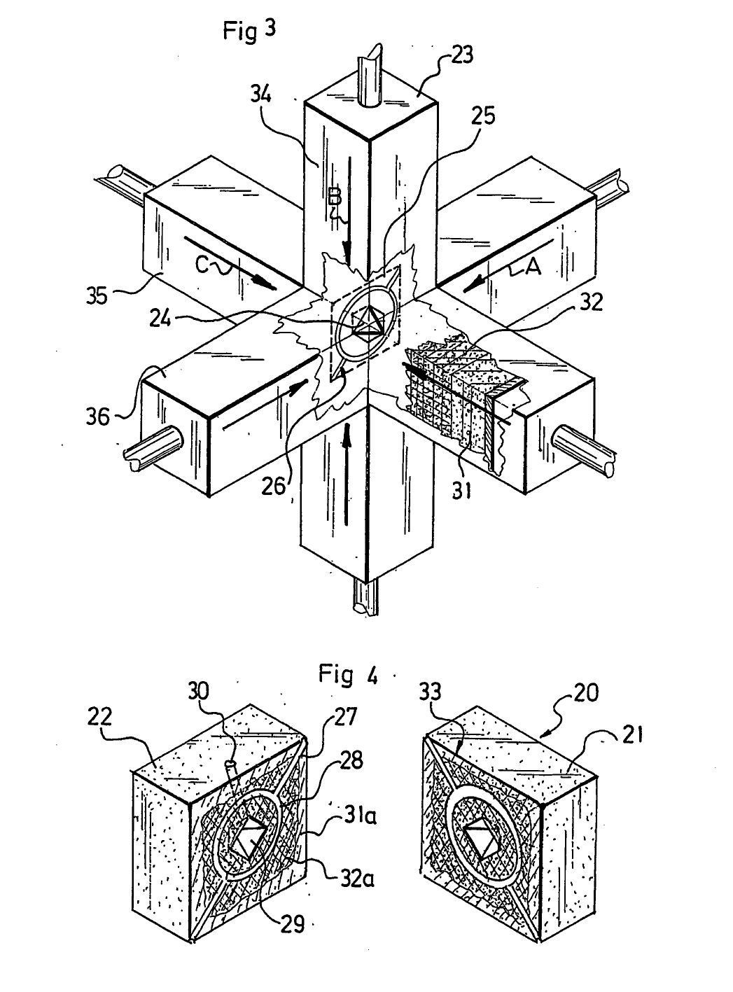

FIG. 3 is a schematic, partially cut-away perspective view of another press used according to the first version of the invention to produce a mold;

FIG. 4 is a perspective view of another two-part mold according to the invention;

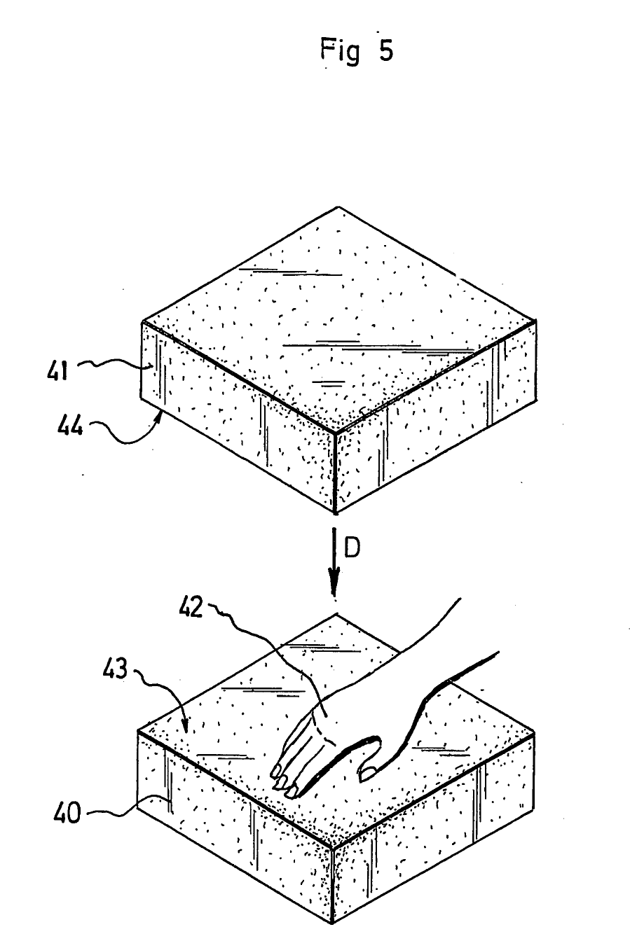

FIG. 5 is a perspective view illustrating a method according to the second version of the invention.

FIG. 1 illustrates a mold-making method according to the first version of the invention. A pattern 3 having the shape of the objects that are to be reproduced by means of the mold is placed into a uniaxial press 1 having square- or rectangular-section plates, a transverse separation sheet 7 separating the press into two parts along the median plane of the pattern 3, and a rigid removable or destructible tube 4, preferably filled, extending between the pattern 3 and a wall of the press 1.

A first layer 5 of expanded graphite is then formed on one side of the separation sheet 7, that is, around a first half of the pattern 3, and a second layer 6 of expanded graphite is likewise formed on the other side of the separation sheet 7, that is, around the other half of the pattern 3. The layers 5 and 6 that have been formed thus completely cover the pattern 3.

The layers of expanded graphite are then compressed by actuating at least one of the plates 2 of the press until they are consolidated. The compression ratio applied is selected as a function of the intended use of the mold and in particular of the moldable material. In the case of a foundry mold, the layers are so compressed as to obtain consolidated blocks of graphite having a density greater than 100 kg/m³.

The two parallelepipedic graphite blocks 5a, 6a thus consolidated by compression are then withdrawn from the press, and then separated along the plane of the joint demarcated by the separation sheet 7. Said separation sheet, the pattern 3 and the tube 4 are withdrawn. A mold having two parts 11, 10, each corresponding to a consolidated block, is obtained. The part 11 includes a concave impression 9 formed in the consolidated graphite block 6a and corresponding substantially to one half of the pattern. The part 10 includes a concave impression 8 formed in the consolidated graphite block 5a and corresponding substantially to the other half of the pattern, together with a flow passage 12 left behind by the tube 4 and extending between the impression 8 and an external face of the block.

Each block 10, 11 also includes linear capture forms 13 in the form of grooves, and punctual capture forms 14 in the form of pointed cavities, on its exterior faces 15, 16 against which the press plate has been applied. To produce this effect the plates of the press used are each provided with an imprinting die having corresponding pointed projections and ribs (not shown) which have a depth (dimension in the direction of compression) ranging from 1 cm to 5 cm and a width ranging from 1 mm and 1 cm. The compression of the layers of expanded graphite 5, 6 causes the capture forms to be impressed in the faces 15, 16 of the blocks 10, 11. These forms have dimensions and a geometry adapted to trap infrared waves. The linear forms are, for example, straight (cylindrical) grooves or slots having a semicircular (as at reference 13), square, triangular or trapezoidal cross-section, or curved grooves or slots of any cross-section, etc. The punctual forms are, for example, conical or pyramidal impressions having a square, triangular or hemispherical cross-section, etc.

The geometry of the capture forms may be still more complex and result from mathematical calculations for a dimensioning relative to a particular application, and in particular to a source of radiation having a given wavelength. It should be noted that it is possible to produce diverse and varied capture forms on the same mold (as illustrated), or to provide only one type of capture form (linear or punctual), or to provide only a single pattern of a particular shape.

The capture forms 13, 14 enable both the trapping of infrared waves emitted by a source external to the mold, and increasing of the exchange surface area of the mold, in order to enhance the thermal exchange by radiation between the mold and the outside, and therefore to enhance the efficiency of heating or cooling by radiation.

FIGS. 3 and 4 illustrate another mold-making method according to the first version of the invention. At the centre of a triaxial press 23 there are placed:
a pattern 24 reproducing the objects to be produced with the mold;
a separation sheet 25 surrounding the pattern along a median plane of the latter;
a network 26 of rigid tubes provided in the separation sheet and designed to form conduits for receiving a heating/cooling liquid within the mold;
a tube (not shown) extending at least between the pattern and a plane of intersection of two pillars of the press in order to form a flow passage into the mold.

Expanded graphite 32 is introduced into each pillar 34, 35, 36 on both sides of the pattern so as to form two layers of expanded graphite separated at the centre of the press by the separation sheet 25. Expanded vermiculite 31 which covers the layers of expanded graphite is then introduced into each pillar 34, 35, 36 of the press at each end of the pillar.

The layers formed are then compressed by displacing the six plates of the press towards the centre of the latter, the plates of the pillar 35 being driven in the direction C, those of the pillar 34 in the direction B and those of the pillar 36 in the direction A, until they meet to form a cube.

The mold formed is then withdrawn from the press, and then opened along its joint plane 33 demarcated by the separation sheet 25. The sheet 25, the tubes 26, the flow tube and the pattern 24 are withdrawn from the mold. In this way a mold in two parts 21, 22, each part corresponding to a mixed consolidated block, is obtained. Each part or half of the mold comprises an inner consolidated layer 32a of recompressed expanded graphite which delimits an impression 29, and an outer consolidated layer 31a of recompressed expanded vermiculite which covers the layer 32a and forms an insulating protection of the mold.

The quantities of expanded graphite and expanded vermiculite introduced into the press to form the corresponding layers are selected as a function of the dimensions of the press and of the desired final density of the consolidated layers 31a and 32a.

Each mold half 21, 22 also includes grooves 27, 28 which, with the conjugate grooves of the other half of the mold, form passages for the circulation of a mold heating/cooling liquid. At least one of the mold halves 21, 22 additionally includes a flow passage 30 extending between an external-face of the mold and the impression 29. The flow passage serves for the introduction or injection of the moldable material, preferably in liquid form.

It should be noted that an independent circuit for the circulation of heating/cooling liquid may be formed in the graphite layer 32a of each of the mold halves. Such a procedure is preferred, since it ensures complete fluid-tightness of the circuits. It should also be noted that it is possible to insert electrical resistors (cables), designed to be connected to a current generator in order to heat the mold by radiation, into each layer of expanded graphite prior to any compression.

It is also possible, in order to obtain a mold according to the invention, to use a uniaxial press such as that shown in FIG. 1, to form two layers of expanded graphite, one on each side of a pattern, then to form two layers of expanded vermiculite, one on each side of the graphite layers, and then to compress the layers in a single direction. A parallelepipedic mold (formed by two mixed blocks) is obtained, only two opposed faces of which are insulated by a consolidated layer of vermiculite.

As a variant, the four layers previously consolidated (together with the pattern) are replaced in the uniaxial press in such a way that the vermiculite layers extend parallel to the compression direction C of the press, and then the layers are recompressed. The mold thus obtained is formed by two mixed blocks that have been compressed successively in two orthogonal directions. The operation may be repeated in such a way as to compress the layers in a third direction orthogonal to the first two.

Prior to each of the above-mentioned second and third compressions, it is possible to form two new layers of expanded vermiculite, one on each side of the layers previously consolidated. In this way a parallelepipedic mold (of two mixed blocks) is obtained, four faces of which are insulated by a consolidated vermiculite layer if only two compressions are carried out, or the six faces of which are insulated if three compressions are carried out.

It should be noted that, in the case of a mold having at least one face devoid of insulating vermiculite protection, the temperature within the mold may also be controlled and adjusted by heating/cooling of said face(s) through contact of said face(s) with a heating body and then by thermal conduction into the consolidated graphite mass. Thus, as a result of the advantageous thermal properties of recompressed expanded graphite, it is not necessary to form or insert a heating/cooling circuit within the graphite layer in order to be able to control the temperature of the mold around the impression.

FIG. 5 illustrates a method for molding a hand according to the second version of the invention. To carry this out, two pre-consolidated layers 40, 41 formed by expanded graphite that has been lightly recompressed in one direction in a uniaxial press, such as that utilized in FIG. 1, are used. In the example illustrated, the layers have been pre-consolidated by compression in a direction parallel to the direction D. It should be noted that it is possible to use pre-consolidated layers formed by expanded graphite recompressed in a plurality of directions, in particular in three orthogonal directions. However, such a procedure needlessly increases the manufacturing cost.

The layers 40, 41 preferably have a density ranging from 30 to 35 kg/m³, that is, very slightly greater than the consolidation density of the expanded graphite. Such pre-consolidated layers are therefore still very malleable. A low pressure is enough to leave an impression in the graphite.

According to the invention, the hand 42 to be molded is placed between the two layers 40, 41, and then said layers are pressed against the hand in the direction D. In particular, a compression force is applied to the upper face of the layer 41 until the layers entirely envelop the hand, that is, until their opposed faces 44, 43 meet. The two consolidated layers, called consolidated blocks, are then separated in order to withdraw the hand from the mold.

According to this method, it is not necessary to provide a separation sheet between the two layers 40, 41. Because the layers are pre-consolidated they have a laminated structure of parallel flakes which can slide with respect to one another, which flakes are orthogonal to the direction of pre-consolidation of the layers and therefore, in the present example, are orthogonal to the direction D. The pressure exerted on the layers 40, 41 to form the mold is transmitted to the parallel flakes forming the surfaces 43 and 44 by stresses orthogonal to said flakes which are insufficient to cause imbrication of same.

It is self-evident that the invention may be the subject of numerous variants with respect to the embodiments described previously and illustrated in the Figures.

In particular, the invention enables the production not only of two-part molds such as those illustrated but also of one-piece molds (such molds must be destroyed to remove the object) or molds in three parts or more. Moreover, the presses used may be of any type and any section.

1.-30. (canceled)

31. A method for producing a mold for molding objects in a material, called the moldable material, whereby a pattern of the objects to be molded is used and the pattern is covered with material, called the molding material, wherein expanded graphite is utilized as the molding material, the pattern is covered with expanded graphite to form a continuous layer of expanded graphite or a plurality of separated layers of expanded graphite distributed over the pattern, and the layer(s) of expanded graphite are then compressed against the pattern so as to obtain for each layer a consolidated graphite block which is impermeable to the moldable material.

32. A method as claimed in claim 31, wherein a first layer of expanded graphite is formed on one side of the pattern and a second layer of expanded graphite is formed on the other side of the pattern so as to completely envelop the pattern, in order to obtain a mold in two parts.

33. A method for producing a mold for molding objects in a material, called the moldable material, whereby a pattern of the objects to be molded is used and is covered with a material, called the molding material, wherein expanded graphite is utilized as the molding material, at least one layer, called a pre-consolidated layer, of expanded graphite recompressed in at least one direction so as to have a density ranging from 30 to 50 kg/m³, is used, the pre-consolidated layer(s) is/are placed on the pattern and said pre-consolidated layer(s) are then compressed against the pattern so as to cover the pattern and to obtain for each layer a consolidated graphite block which is impermeable to the moldable material.

34. A method as claimed in claim 31, wherein the layer(s) of expanded or pre-consolidated graphite is/are compressed so as to obtain a consolidated block or blocks of graphite having a density greater than 40 kg/m³.

35. A method as claimed in claim 31, wherein the layer(s) of expanded or pre-consolidated graphite is/are compressed so as to obtain a consolidated block or blocks of graphite having a density greater than 100 kg/m³.

36. A method as claimed in claim 31, wherein the layer(s) of expanded or pre-consolidated graphite is/are compressed in a plurality of directions.

37. A method as claimed in claim 31, wherein the layer(s) of expanded or pre-consolidated graphite is/are compressed in three orthogonal directions.

38. A method as claimed in claim 31, wherein the layer(s) of expanded or pre-consolidated graphite is/are compressed in a single direction.

39. A method as claimed in claim 31, wherein the layer(s) of expanded or pre-consolidated graphite is/are subjected to a single compression operation in each direction.

40. A method as claimed in claim 31, wherein the layer(s) of expanded or pre-consolidated graphite is/are subjected to a single compression operation.

41. A method as claimed in claim 31, wherein the layer(s) of expanded or pre-consolidated graphite is/are subjected to a plurality of distinct compression operations in at least one direction.

42. A method as claimed in claim 31, wherein a first compression adapted to consolidate the layer(s) of expanded graphite is carried out in at least one direction in order to permit its/their manipulation, and subsequently a second compression in said direction adapted to impart a desired density to the consolidated block(s) is carried out.

43. A method as claimed in claim 31, wherein a natural expanded graphite is used as the expanded graphite.

44. A method as claimed in claim 31, wherein at least one layer of expanded graphite is covered, at least partially, with a layer of expanded vermiculite, and all the layers formed are then compressed together so as to obtain, for each layer of vermiculite formed, a block, called a mixed block, of consolidated graphite/vermiculite.

45. A method as claimed in claim 33, wherein at least one of the pre-consolidated layers used is a layer, called a mixed layer, formed from at least two superimposed layers, one of expanded graphite and another of expanded vermiculite, compressed together in at least one direction in such a way that the graphite has a density ranging from 30 to 50 kg/m³ and the vermiculite is consolidated, each mixed layer used being disposed on the pattern in such a way that the graphite layer is oriented towards the pattern.

46. A method as claimed in claim 31, wherein heating/cooling elements are placed in at least one layer of expanded or pre-consolidated graphite during its formation.

47. A method as claimed in claim 31, wherein at least one passage able to receive a heating/cooling fluid is formed directly in the graphite mass of at least one block, by placing at least one destructible or removable tube in the corresponding layer of expanded or pre-consolidated graphite during its formation, said tube(s) being destroyed or withdrawn once said block has been consolidated.

48. A method as claimed in claim 31, wherein, during the compression of the layer(s) of expanded or pre-consolidated graphite, open concave forms, called capture forms, adapted to trap infrared waves, are impressed into at least one face, called an exterior face, of at least one block.

49. A method as claimed in claim 48, wherein the impressed capture forms have at least one frontal dimension ranging from 1 μm to 2 cm and a depth ranging from 1 μm to 10 cm.

50. A mold obtained using a method as claimed in claim 31.

51. A mold as claimed in claim 50, wherein it comprises at least one consolidated block, called a mixed block, having at least two bonded layers, including a layer of recompressed expanded graphite and a layer of recompressed expanded vermiculite at least partially covering said layer of graphite.

52. A mold as claimed in claim 50, wherein it includes at least one consolidated block having at least one face, called an exterior face, of graphite which is provided with open concave impressed forms, called capture forms, adapted to trap infrared waves.

53. A mold as claimed in claim 52, wherein the capture forms have at least one frontal dimension ranging from 1 μm to 2 cm and a depth ranging from 1 μm to 10 cm.

54. A foundry mold as claimed in claim 50.

55. A mold, called an orthopedic mold, for molding orthoses or prostheses, as claimed in claim 50.

56. An art mold as claimed in claim 50.

57. A method for molding objects, wherein a mold as claimed in claim 50 is used.

58. A foundry method for casting a molten alloy, wherein a mold as claimed in claim 54 is used.

59. A method for molding orthoses or prostheses, wherein a mold as claimed in claim 55 is used.

60. A method for reproducing a work of art of the sculpture type, wherein a mold as claimed in claim 56 is used.
